(19) United States
(12) Patent Application Publication
(10) Pub. No.: US 2007/0095557 A1
(43) Pub. Date: May 3, 2007

(54) FLAT CABLE AND ELECTRONIC DEVICE USING THE SAME

(75) Inventor: Ching-Jen Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 11/530,027

(22) Filed: Sep. 8, 2006

(30) Foreign Application Priority Data
Oct. 27, 2005 (TW) 94137591

(51) Int. Cl. H01B 7/08

(52) U.S. Cl. 174/117 F

(57) ABSTRACT

An electronic device includes a first circuit board, a second circuit board and a flat cable. The flat cable is electrically connected between the first circuit board and the second circuit board. The flat cable includes an insulation material, a plurality of signal lines, at least a grounding line and a conductive foil. The signal lines are disposed inside the insulation material. A first portion of the grounding line is exposed outside of the insulation material. A second portion of the grounding line is enclosed by the conductive foil and contacted with the conductive foil.

### CROSS-REFERENCE TO RELATED APPLICATION

This application claims the priority benefit of Taiwan application serial no. 94137591, filed on Oct. 27, 2005. All disclosure of the Taiwan application is incorporated herein by reference.

### BACKGROUND OF THE INVENTION

1. Field of Invention

The present invention relates to a flat cable and an electronic device using the same, and particularly to a flat cable capable of anti electromagnetic interference (anti-EMI) and an electronic device using the same.

2. Description of the Related Art

With the development of electronic technology, various electronic products have been widely used at work and in life. Among various electronic products, flat cables are massively used as a signal transmission medium. However, when a flat cable transmits signals, high-frequency and high-energy electromagnetic waves are created. The electromagnetic waves not only cause the parts inside an electronic product an electromagnetic interference (EMI), but also jeopardize human health. Therefore, many countries in the world set a rather strict rule on the electromagnetic wave intensity produced by an electronic product.

To solve the EMI problem during the use of a flat cable, in the prior art, a conductive fabric is used to wrap the flat cable and a conductive wire is pulled out from the conductive fabric to be in contact with the surrounding metal parts, or a conductive fabric is used to be directly in contact with the surrounding metal parts. Hence, the electro-magnetic waves generated by the flat cable can be shielded by the conductive fabric and be released to the surrounding metal parts directly or through the conductive wire. In this way, the electromagnetic waves generated by the flat cable can be prevented from leaking outside. However, the above-described method can be put into practice only when there are metal parts around the flat cable. Besides, the method heavily depends on labors for wrapping the conductive fabric on the flat cable resulting in a waste of the manpower and time. Furthermore, the flat cable after wrapped with a conductive fabric becomes not only bulky, but also hard to be bended and difficult to be used.

### SUMMARY OF THE INVENTION

An object of the present invention is to provide a flat cable for solving electromagnetic interference (EMI) problem; the flat cable is also easy to be fabricated and used.

Another object of the present invention is to provide an electronic device capable of solving the EMI problem.

The present invention provides a flat cable which includes an insulation material, a plurality of signal lines, at least one grounding line having a first portion and a second portion, and a conductive foil. The signal lines are disposed inside the insulation material; a first portion of the grounding line is exposed outside the insulation material; the conductive foil encloses the insulation material and is in contact with the second portion of the grounding line.

The present invention further provides an electronic device which includes a first circuit board, a second circuit board and an above-described flat cable. The flat cable is electrically connected between the first circuit board and the second circuit board.

In an embodiment of the above-described flat cable and electronic device, the flat cable further includes a conductive resin, disposed between the first portion and the conductive foil.

In an embodiment of the above-described flat cable and electronic device, the conductive foil is, for example, a metal foil, preferably an aluminum foil.

In an embodiment of the above-described flat cable and electronic device, a part of the first portion of the grounding line is exposed outside of the insulation material and the conductive foil.

In an embodiment of the above-described flat cable and electronic device, the grounding line is entirely or partially exposed outside of the insulation material.

In summary, in the flat cable and the electronic device using the same of the present invention, since the flat cable has a conductive foil which encloses the insulation material and is in contact with the grounding line, the electromagnetic waves can be shielded by the conductive foil and directly released through the grounding line.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a top view of a flat cable in an embodiment of the present invention.

FIG. 2 is a cross-sectional drawing along sectioning plane I-I in FIG. 1.

FIG. 3 and FIG. 4 are cross-sectional drawings of two flat cables in another two embodiments of the present invention.

FIGS. 5 through 7 illustrate three embodiments of the second portion of the grounding line in a flat cable of the present invention.

FIG. 8 is a schematic drawing of an electronic device in an embodiment of the present invention.

### DESCRIPTION OF THE EMBODIMENTS

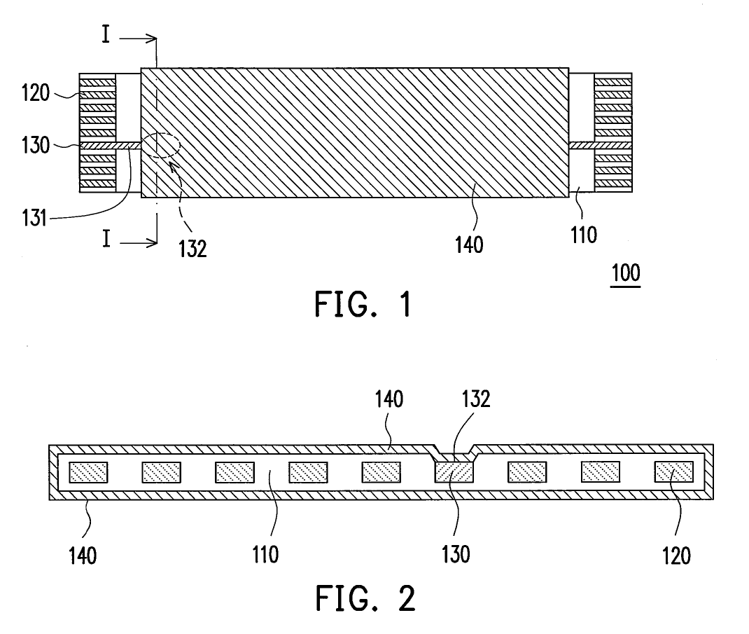

FIG. 1 is a top view of a flat cable in an embodiment of the present invention and FIG. 2 is a cross-sectional drawing along sectioning plane I-I in FIG. 1. Referring to FIGS. 1 and 2, a flat cable 100 of the embodiment includes an insulation material 110, a plurality of signal lines 120, at least one grounding line 130 and a conductive foil 140. In this embodiment, the insulation material 110 may be polyester (PET) or other insulation materials. The signal lines 120 are disposed inside the insulation material 110 for transmitting signals. The grounding line 130 is exposed outside of the insulation material 110 and is covered by the conductive foil 140. For example, the grounding line 130 has a first portion 131 and a second portion 132. The first portion 131 of the grounding line 130 is exposed outside of the insulation material 110 and a part of the first portion 131 is exposed outside of the insulation material 110 and the conductive foil 140. The second portion 132 of the grounding line 130, as shown by an area circled by the dotted line in FIG. 1, is covered by the conductive foil 140 and contacts with the conductive foil 140, i.e., as shown in FIG. 2, the second portion 132 of the grounding line 130 contacts with the conductive foil 140.

Since the conductive foil 140 encloses the insulation material 110, that is, the signal lines 120 are also enclosed by the conductive foil 140, thus, the electromagnetic waves generated by the signal lines 120 during transmitting signals can be shielded by the conductive foil 140 from leaking. Furthermore, the electromagnetic waves are released outside through the grounding line 130 which is in contact with the conductive foil 140. It should be noted that such a design of shielding electromagnetic waves can be employed to a grounding system which is connected by the grounding line 130 for releasing the electromagnetic waves, thus an extra path for releasing the electromagnetic waves can be saved. Furthermore, the scheme is feasible under the circumstance of having no metal parts around the flat cable. In addition, the flat cable 100 can be more easily fabricated than the conventional approach where the flat cable is wrapped by a conductive fabric. Therefore, labors and working hours are significantly reduced. Moreover, the volume of the flat cable 100 does not change a lot, so that the flat cable 100 still maintains the advantages of being bended and used easily.

In the flat cable 100 of the present embodiment, the quantity of the grounding line 130 is one piece considered as exemplary only. In fact, the grounding line 130 can be a plurality of lines. The material of the grounding line 130 and of the signal lines 120 is, for example, metal, preferably a copper line, and a tinned copper line is the most desired. Further, on the surfaces of both ends of the grounding line 130 and the signal lines 120, which are used for being in contact with other electronic components so as to be exposed outside, a gold layer (not shown) can be optionally plated, respectively, to have an anti-oxidation effect. The conductive foil 140 is, for example, a metal foil, preferably an aluminum foil.

In more detail, the flat cable 100 can be a so-called flexible flat cable (FFC), where the grounding line 130 and signal lines 120 thereof normally have a flat cross-section. An FFC has the advantages of full-automatic, massive and fast production, low cost, flexible nature, easiness of bending and folding, thin thickness, connection simplicity, disassembly convenience and so on. Certainly, the above-described design of the conductive foil 140 being in contact with the grounding line 130 provided by the present invention further advances the capability of shielding electro-magnetic waves of the flat cable 100 and widens the application fields thereof.

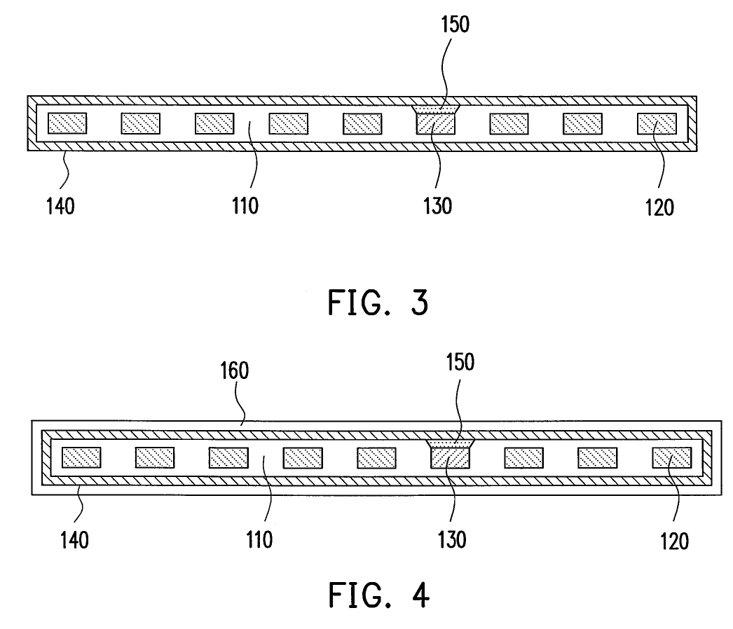

FIG. 3 and FIG. 4 are cross-sectional drawings of two flat cables in another two embodiments of the present invention. Referring to FIG. 3, the flat cable of the embodiment further includes a conductive resin 150, disposed between the grounding line 130 and the conductive foil 140 for assuring the contact between the grounding line 130 and the conductive foil 140. Referring to FIG. 4, the flat cable of the embodiment further includes an insulation film 160, which encloses the outer surface of the conductive foil 140 for preventing the surface of the conductive foil 140 from oxidation. The insulation film 160 is, for example, a common plastic film.

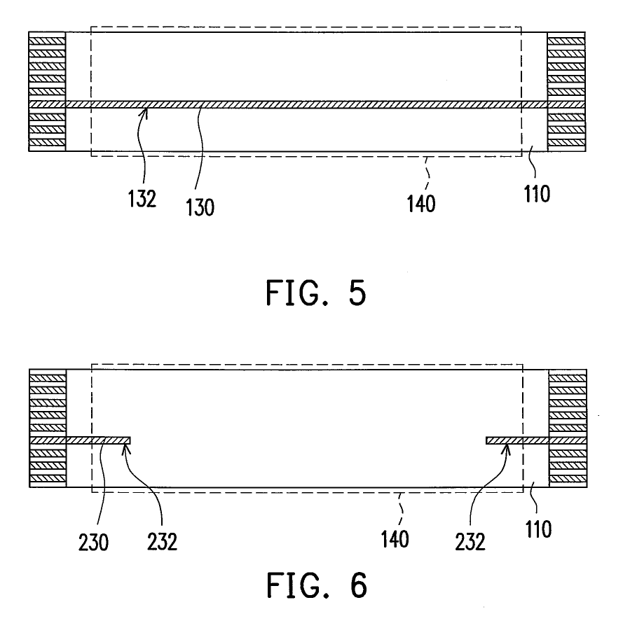

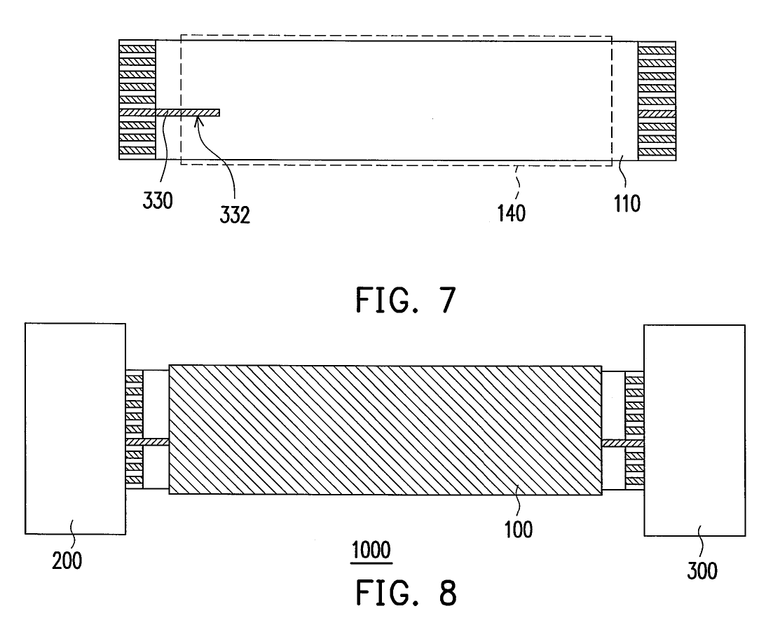

FIGS. 5 through 7 illustrate three embodiments of the second portion of the grounding line in a flat cable of the present invention. Referring to FIG. 5, the second portion 132 of the grounding line 130 in the embodiment is shown by an arrow, which indicates the upper surface of the whole grounding line 130 is exposed outside of the insulation material 110. Referring to FIG. 6, the second portion 232 of the grounding line 230 in the embodiment is shown by an oblique-lined area, which indicates only a partial upper surface of the grounding line 230 is exposed outside of the insulation material 110 and is in contact with the conductive foil 140. Referring to FIG. 7, the second portion 332 of the grounding line 330 in the embodiment locates at the left side in FIG. 7. The above-described three embodiments of the second portion of a grounding line shown in FIGS. 5-7 are considered as exemplary only, for anyone skilled in the art it should be known that the layout of a second portion of a grounding line being in contact with the conductive foil in the present invention is not limited by the above description. As long as the grounding line is able to be in contact with the conductive foil so that the conductive foil is capable of shielding electromagnetic waves, variations and modifications can be made to meet practical requirement.

FIG. 8 is a schematic drawing of an electronic device in an embodiment of the present invention. Referring to FIG. 8, an electronic device 1000 of the embodiment includes a first circuit board 200, a second circuit board 300 and a flat cable 100. The flat cable 100 is electrically connected between the first circuit board 200 and the second circuit board 300, served as a signal transmission path in-between. It should be noted that the flat cable 100 may be any flat cable having the features of the above embodiments of the present invention. Therefore, the first circuit board 200, the second circuit board 300 or the other electronic components in the electronic device 1000 are beneficial from the invention, i.e. have a reduced electro-magnetic interference (EMI) generated by the flat cable 100. Besides, the flat cable 100 can be bended and folded freely with an extremely thin thickness, thus, the electronic device 1000 would meet the design requirement of smallish outlook.

As mentioned previously, in the flat cable and the electronic device using the same of the present invention, a conductive foil is used for enclosing the insulation material and is in contact with the grounding line. Hence, the electromagnetic waves can be shielded by the conductive foil and directly released outside through the grounding line. Meanwhile, the flat cable of the present invention can be applied under a circumstance of having no metal parts around the flat cable, with the same effect of shielding electromagnetic waves. As a result, fabrication becomes easier, labors and working hours are saved, bending and folding are easy and convenient, and the cost is lowered. In addition, the flat cable of the present invention is flexible, thin, easy for connection, convenient in disassembly and so on. Moreover, the electronic device using the above-described flat cable of the present invention meets the design requirement of smallish outlook.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A flat cable, comprising:
an insulation material;
a plurality of signal lines, disposed inside the insulation material;
at least a grounding line, having a first portion and a second portion, wherein the first portion of the grounding line is exposed outside of the insulation material; and
a conductive foil, enclosing the insulation material and is in contact with the second portion of the grounding line.

2. The flat cable as recited in claim 1, further comprising a conductive resin disposed between the second portion and the conductive foil.

3. The flat cable as recited in claim 1, wherein the conductive foil is a metal foil.

4. The flat cable as recited in claim 1, wherein a part of the first portion of the grounding line is exposed outside of the insulation material and the conductive foil.

5. The flat cable as recited in claim 1, wherein the grounding line is at least partially exposed outside of the insulation material.

6. An electronic device, comprising:
a first circuit board;
a second circuit board;
a flat cable, electrically connected between the first circuit board and the second circuit board; the flat cable comprising:
an insulation material;
a plurality of signal lines, disposed inside the insulation material;
at least a grounding line, having a first portion and a second portion, wherein the first portion of the grounding line is exposed outside of the insulation material; and
a conductive foil, enclosing the insulation material and is in contact with the second portion of the grounding line.

7. The electronic device as recited in claim 6, wherein the flat cable further comprises a conductive resin disposed between the second portion and the conductive foil.

8. The electronic device as recited in claim 6, wherein the conductive foil is a metal foil.

9. The electronic device as recited in claim 6, wherein a part of the first portion of the grounding line is exposed outside of the insulation material and the conductive foil.

10. The electronic device as recited in claim 6, wherein the grounding line is at least partially exposed outside of the insulation material.
